(19) United States
(12) Patent Application Publication
(10) Pub. No.: US 2013/0202894 A1
(43) Pub. Date: Aug. 8, 2013

(54) GLASS-AND-PLASTIC COMPOSITE AND METHOD FOR MAKING SAME

(71) Applicants: CHIA-WEN TSAO, Shindian (TW); SHU-XIANG ZHOU, Shenzhen City (CN); YUEH-CHE HSIEH, Shindian (TW)

(72) Inventors: CHIA-WEN TSAO, Shindian (TW); SHU-XIANG ZHOU, Shenzhen City (CN); YUEH-CHE HSIEH, Shindian (TW)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/524,309

(22) Filed: Jun. 15, 2012

(30) Foreign Application Priority Data
Feb. 6, 2012 (CN) 201210025130.1

(51) Int. Cl. B32B 17/10; B29C 45/14

(52) U.S. Cl. 428/425.5; 264/135; 428/429

(57) ABSTRACT

A method for making a glass-and-plastic composite includes the following steps: providing a glass article; forming an activation solution containing hydrolyzed silane coupling agent; coating the activation solution on the surface of the glass article and drying the activation solution to form a silane coupling agent layer; coating a fluid glue on the silane coupling agent layer and drying the fluid glue to form a glue layer; and forming a plastic article on the glue layer by injection molding. The plastic article firmly bonds with the glass article.

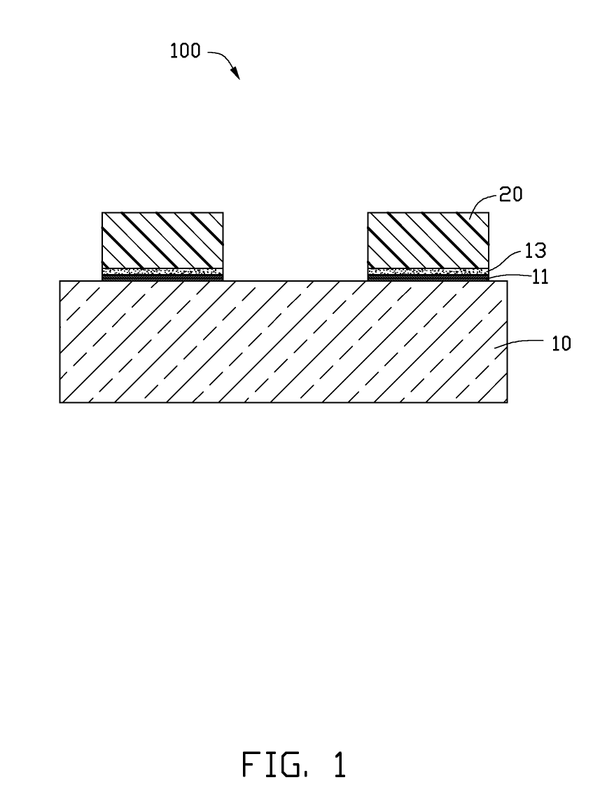

### BACKGROUND

1. Technical Field

The present disclosure relates to a glass-and-plastic composite and method for making the glass-and-plastic composite.

2. Description of Related Art

Glass housings of electronic devices can present aesthetically pleasing appearances. Plastic latching members or threaded posts are usually adhered to the glass housing for assembling of the electronic device using fluid glue or solid binder. However, the bond between the glass housing and the plastic latching members and threaded posts is not always strong enough.

Therefore, there is room for improvement within the art.

### BRIEF DESCRIPTION OF THE DRAWING

Many aspects of the composite can be better understood with reference to the following drawing. The components in the drawing are not necessarily drawn to scale, the emphasis instead being placed upon clearly illustrating the principles of the composite. Moreover, in the drawing like reference numerals designate corresponding parts throughout the drawing.

The FIGURE is a cross-sectional view of an exemplary embodiment of a composite.

### DETAILED DESCRIPTION

The FIGURE shows a glass-and-plastic composite 100 according to an exemplary embodiment. A method for making the glass-and-plastic composite 100 may include at least the following steps:

A glass article 10 is provided.

The glass article 10 is surface activated to improve the bond between the glass article 10 and the subsequent plastic article 20.

An activation solution is manufactured by mixing a silane coupling agent and water. The mass ratio of the silane coupling agent to water is about 3:97 to about 5:95. The silane coupling agent then hydrolyzes in water. The hydrolyzing process may last for about 25 min to about 40 min to get the activation solution. The activation solution is then coated evenly on part of the surface of the glass article 10. The coated glass article 10 is dried at an air temperature of about 80° C. to about 120° C. for about 5 min to about 10 min, allowing the silane coupling agent to completely react with the glass article 10 to form a silane coupling agent layer 11 on the article 10.

The surface of the glass article 10 has many Si—OH groups, and the silane coupling agent layer 11 also has many Si—OH groups. The Si—OH groups of the glass article 10 react with the Si—OH groups of the silane coupling agent layer 11 to form Si—O—Si groups, enhancing the bond between the glass article 10 and the silane coupling agent layer 11.

A fluid glue is coated on the surface of the silane coupling agent layer 11 and then dried at an air temperature of about 40° C. to about 60° C. for about 10 min to about 20 min to form a glue layer 13 on the silane coupling agent layer 11. The fluid glue is a type of glue containing amino functional groups. The fluid glue in the exemplary embodiment may contain polyurethane and ethyl acetate, wherein the mass ratio of polyurethane to ethyl acetate is about 10:7. The ethyl acetate is used as diluent. The epoxy groups contained in the silane coupling agent layer 11 react with the amino groups of the polyurethane of the fluid glue, enhancing the bond between the silane coupling agent layer 11 and the glue layer 13. As a result, the bond between the subsequent plastic article 20 and the glass article 10 is also improved.

A plastic article 20 is formed on the glass article 10 by injection molding to obtain the glass-and-plastic composite 100. The glass article 10 having the glue layer 13 is put into an injection mold (not shown), and molten plastic material is injected on the glue layer 13 and then cooled to form the plastic article 20. The plastic article 20 may be a latch member or a threaded post. The plastic article 20 can securely bond with the glass article 10.

The glass-and-plastic composite 10 made by the method includes the glass article 10 and the plastic article 20. The silane coupling agent layer 11 and the glue layer 13 are defined between the glass article 10 and the plastic article 20, wherein the silane coupling agent layer 11 bonds directly to the glass article 10, and the glue layer 13 bonds directly to the plastic article 20. The glue layer 13 contains amino functional groups. In the exemplary embodiment, the glue layer 13 contains polyurethane.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A method for making a glass-and-plastic composite, comprising:
providing a glass article;
forming an activation solution containing hydrolyzed silane coupling agent;
coating the activation solution on the surface of the glass article and drying the activation solution to form a silane coupling agent layer;
coating a fluid glue containing amino groups on the silane coupling agent layer and drying the glue to form a glue layer; and
forming a plastic article on the glue layer by injection molding.

2. The method as claimed in claim 1, wherein the step of forming an activation solution comprises mixing a silane coupling agent and water.

3. The method as claimed in claim 2, wherein mass ratio of the silane coupling agent to water is about 3:97 to about 5:95.

4. The method as claimed in claim 1, wherein the step of forming the activation solution comprises hydrolyzing the hydrolyzed silane coupling agent for about 25 min to about 40 min.

5. The method as claimed in claim 1, wherein the drying of the activation solution is carried out at an air temperature of about 80° C. to about 120° C. for about 5 min to about 10 min.

6. The method as claimed in claim 1, wherein the fluid glue contains polyurethane and ethyl acetate.

7. The method as claimed in claim 6, wherein mass ratio of polyurethane to ethyl acetate is about 10:7.

8. The method as claimed in claim 1, wherein the drying of the fluid glue is carried out at an air temperature of about 40° C. to about 60° C. for about 10 min to about 20 min.

9. A glass-and-plastic composite, comprising:
a glass article;
a silane coupling agent layer bonded to the glass article;
a glue layer bonded to the silane coupling agent layer; and
a plastic article bonded to the glue layer.

10. The glass-and-plastic composite as claimed in claim 9, wherein the glue layer contains amino functional groups.

11. The glass-and-plastic composite as claimed in claim 9, wherein the glue layer contains polyurethane.
